(19) United States
(12) Patent Application Publication
(10) Pub. No.: US 2020/0041229 A1
(43) Pub. Date: Feb. 6, 2020

(54) DEVICE AND METHOD FOR MONITORING AND INTERVENTION

(71) Applicant: Samuel DESSET, Bourg Charente (FR)

(72) Inventor: Samuel DESSET, Bourg Charente (FR)

(21) Appl. No.: 16/484,632

(22) PCT Filed: Feb. 9, 2018
(86) PCT No.: PCT/FR2018/050314

§ 371 Date: Aug. 8, 2019

(30) Foreign Application Priority Data
Feb. 10, 2017 (FR) 1751132

(51) Int. Cl. F41G 3/16; G01S 17/88; G01S 17/08; G05D 1/00; B25J 5/00; B25J 15/00; B25J 13/00

(52) U.S. Cl. CPC F41G 3/165; G01S 17/88; G01S 17/08; G05D 1/0038; G05D 2201/0209; G05D 1/0022; B25J 5/007; B25J 15/0019; B25J 13/006; G05D 1/0094

(57) ABSTRACT

A device includes a land drone and a control center for controlling the land drone. The land drone includes a mobile base, a support arm, and a head including at least one means for acting and connected to the support arm. The head can be attached to a base assembly and support arm of a platform lift of a military vehicle and converted into a drone. The adaptability of a head on various types of platform lifts allows a land drone to be rapidly deployed in a hostile environment. The choice of means for acting makes it possible to confront various types of risk situations. In particular, the device may be deployed in a military context, for example, urban combat, in which the base of the drone is a military vehicle, for example, a tank. A method for implementing a device is also provided.

### CROSS REFERENCE TO RELATED APPLICATIONS

This application is a National Stage of International Application No. PCT/FR2018/050314, having an International Filing Date of 9 Feb. 2018, which designated the United States of America, and which International Application was published under PCT Article 21(2) as WO Publication No. 2018/146427 A1, which claims priority from and the benefit of French Patent Application No. 1751132, filed on 10 Feb. 2017, the disclosures of which are incorporated herein by reference in their entireties.

### BACKGROUND

### 1. Field

The disclosed embodiment relates to the field of unmanned vehicles.

More specifically, the disclosed embodiment relates to the field of remotely operated unmanned vehicles.

More specifically, the disclosed embodiment relates to the field of remotely operated unmanned vehicles operating in environment with risks of attack.

### 2. Brief Description of Related Developments

Intervention of armed forces, law-enforcement or response teams in dangerous or hostile environments (i.e. terrorist attack, riot, urban combat) is bound to risks that could lead to casualties. Prevention and protection measures employed in such environments can lead to limitations, such as off-limit zones or blind spots for individuals operating in this type of environments.

For instance, during demonstration, ground security forces cannot easily monitor the crowd because of their grazing field of view laterally limited to an individual's field of view. During riot or terrorist attack, apart from adverse fire, response forces are equally exposed to risk of crossfire between team's members.

In other example, armed forces entering into city held by adverse forces find themselves targeted by adverse forces positioned at hard to reach and unattainable positions.

In order to assure safety of operators, drones are used to accomplish missions in dangerous environments, as in Chinese utility certificate number CN205239481 that describes land-based robot equipped with automatic steering system with intelligent control and capable of observation and intervention in high risk environments. However, this implementation is automatic, yet in emergency situation it could be necessary to take the control over the drone.

Apart from the utility certificate mentioned earlier, the idea of using the drone for interventions in hazardous environments is known, as in Korean patent application number KR20150036955 that describes remotely controlled drone simulator equipped with system transmitting images from the battlefield and with remote firing system.

However, prior art doesn't describe a method that would allow rapid intervention, in hostile environment, of a drone with equipment suitable for emergency situation

The currently disclosed embodiment proposes the solution to such problem.

### SUMMARY

The disclosed embodiment relates to a device for intervention in dangerous environments.

The device comprises:

A remotely operated land-based drone comprising:
a base being self-propelling and energy self-sufficient;
an arm support consolidated to the base by a lower end of said arm support;
a head consolidated to the upper end of said arm support;

a control center physically separated from the drone and arranged so as to allow remote control of the drone by a remote operator of said control center;

a data transfer system for uploading data from the drone to control center and downloading data from the control center to the drone.

According to the disclosed embodiment

the head comprises:
at least one environment perception system suitable to the wide field visual reconstruction of the drone's environment;
one or more narrow field means for acting employed following a preferred direction defined by an aiming line within the drone's environment wide field visual reconstruction; said aiming line being oriented according a pointer connected to the head;

a remote control center comprises:
a visual display surface for images, suitable for displaying the wide field visual reconstruction of the drone's environment;
a platform of operators, dimensions and a position of said visual display surface being adapted to allow the operators to observe from said platform images displayed on said visual display surface;
one or more portable aiming systems, each one being equipped with an aiming line, wherein each aiming system:
   is intended to be controlled by an operator found on the platform, and equipped with said aiming system;
   controls an only and unique means for acting to which said aiming system is associated;
   is arranged to designate a given point on the visual display surface;
   said aiming system being also provided with a validating control function of the designated point;
      the uploading data comprising information data from the environment perception system, said data being treated upon reception to visually reconstitute the drone's environment and display in real time said reconstruction on the visual display surface;
      the downloading data comprising information transmitted in real time, to orient the at least one means for acting associated with said at least one portable aiming system to point a target in the drone's real environment corresponding to a target corresponding to the point designated on the visual display surface by the aiming system.

Real time of data exchange through data transfer system is a time interval lesser then minimal time interval discernible by operators and the time interval specific to dynamics of the system.
In an alternative aspect of the disclosed embodiment, the base and the arm support come from a military vehicle or civilian aerial work platform.
In an alternative aspect of the disclosed embodiment, the base and the arm support form a sub-unit of the platform lift with articulated or sliding telescopic arm.
In an alternative aspect of the disclosed embodiment, the arm support and the head are interconnected by an adapter.
In an alternative aspect of the disclosed embodiment, data transfer system uses one or more wire connections and one or more radio, terrestrial or satellite connections.
In an alternative aspect of the disclosed embodiment, the at least one environment perception system comprises an image sensor and/or a sweeping distance sensor.
In an alternative aspect of the disclosed embodiment, at least one environment perception system features a field angle greater than 45 degrees and at the least one means for acting features an angle of aperture lesser than 10 degrees.
In an alternative aspect of the disclosed embodiment, the at least one means for acting features at least one potentially lethal weapon.
In an alternative aspect of the disclosed embodiment, at least one of the means of action features a wind speed sensor and or a stabilizer.
In an alternative aspect of the disclosed embodiment, the head is self sufficient in energy.
In an alternative aspect of the disclosed embodiment, control center also comprises a station for one tactical officer and a station for at least one monitoring officer.
In an alternative aspect of the disclosed embodiment, at least one part of the visual display surface of the control center is significantly cylindrical and surrounds platform operators.
In an alternative aspect of the disclosed embodiment, the visual display surface of the control center comprises a part that is mostly dome shaped.
In an alternative aspect of the disclosed embodiment, at least one aiming system comprises a laser and or targeting system.

The disclosed embodiment also refers to the methodology of implementing, in the context of engagement at the intervention site, of the intervention device according to the disclosed embodiment.

According to the disclosed embodiment, this method includes following stages:
determination of a model of said head to implement considering an intervention profile;
extraction from a database of a listing of civilian or military platforms lifts, each equipped with a nacelle, said platform lifts being compatible with the head model determined during the determination stage, identified in said database and located in the given perimeter of the intervention site;
selection of the platform lift identified in the listing as the closest to said intervention site, test of the availability conditions and operability of said platform lift and, in a case of negative result, removing of said platform lift from said listing and rerun of the stage up to the identification of a usable platform lift, if necessary rerun of the stage of the extraction within enlarged perimeter;
transformation of the platform lift into drone by removing the nacelle from the platform lift selected in the selected stage to form a base with the arm support and attaching the head to the above mentioned arm support in order to form a drone of the intervention device;
setting of the drone at the intervention site and coupling said drone with the control center by the data transfer system.

In an alternative mode of implementation, the method comprises a preliminary stage of identifying, in the regularly updated database, the emplacements of the platform lifts equipped with nacelles and located in the area of interest where the intervention site is located.

In an alternative mode of implementation, real time mapping is performed allowing to view the identified platform lifts in the area of interest, i.e. city, region, or country.

In an alternative mode of implementation the method comprises in addition:
a stage of transit of said head from a heads storage area to the chosen platform lift;
a stage of dismantling the head and reinstallation of the nacelle at the end of the device's engagement;
a stage of back transit of the head from the intervention site back to the storage area.

### BRIEF DESCRIPTION OF THE DRAWINGS

The disclosed embodiment will be better understood upon reading of the following description and reviewing joint illustrations. They are for illustrative purposes only and in no way limit the disclosed embodiment.

FIG. 1 represents the land drone and the control center of the device according to the disclosed embodiment, as well as their interactions, in an aspect of the disclosed embodiment.

FIG. 2 represents the land drone of the device according to an aspect of the disclosed embodiment of FIG. 1.

FIG. 3 represents the land drone of the device according to an aspect in a second form of the disclosed embodiment.

FIG. 4 represents the control center according to an aspect off the disclosed embodiment of FIG. 1.

FIG. 5 represents the land drone according to the disclosed embodiment in a first mode of implementation.

FIG. 6 represents the land drone according to the disclosed embodiment in a second mode of implementation.

FIG. 7 represents the land drone according to the disclosed embodiment in a third mode of implementation.

FIG. 8 represents the land drone according to the disclosed embodiment in a forth mode of implementation.

FIG. 9 shows different stages of the method of the implementation of the device according to aspects of the disclosed embodiment.

In the figures, similar elements ensuring similar functions, even if different in form, bare the same mark.

### DETAILED DESCRIPTION

Detailed description below refers to the particular aspects of the disclosed embodiment, which is not limited to those forms only.

Similarly, numeric values are only given as examples and in no way limit the disclosed embodiment.

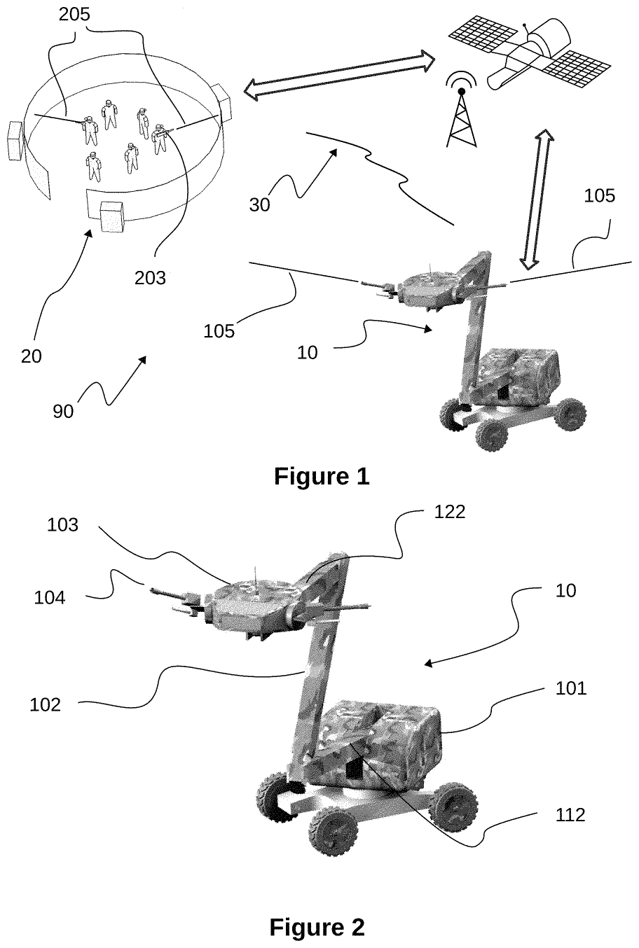

In reference to FIG. 1, the device according aspects of the disclosed embodiment comprises:
a remotely operated land drone 10;
a control center 20;
a data transfer system between the land drone 10 and the control center 20.

Term «land drone» is used in the description to indicate the terrestrial remotely operated unmanned vehicle. Thereafter, the term “drone” alone may be used, to indicate “land drone”.

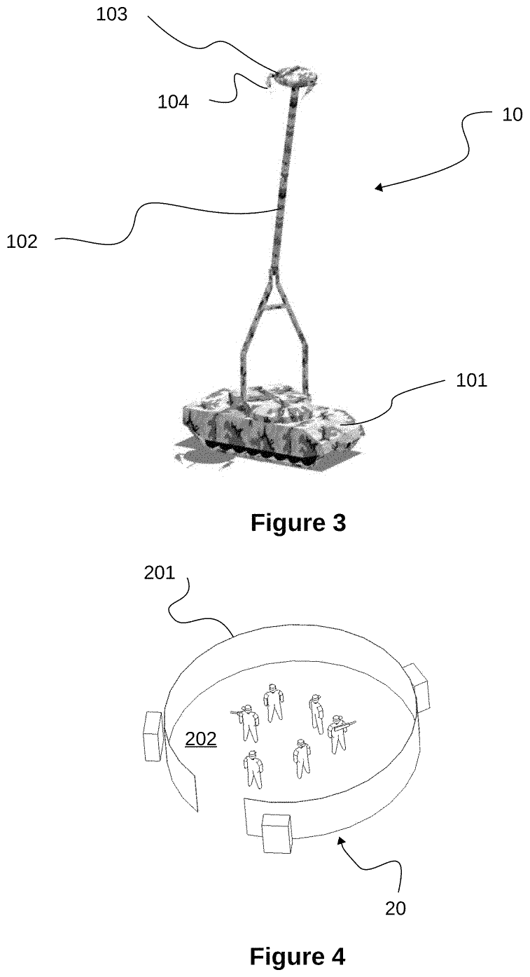

In reference to FIGS. 2 and 3, the drone 10 mainly comprises:
a base 101 being self-propelling and energy self-sufficient;
an arm support 102;
a head 103.

Self propelling base 101 and arm support 102 form a carrier vehicle able to move on the ground.

In the example of aspects illustrated by FIGS. 1 and 2, the base 101 comprises:
a mechanical frame equipped with 4 wheels of which at least two are steerable and at least one is motorized. As it will be understood later, for the ease of the base 101 road handling, the four wheels are preferably motorized and steerable;
a mounted turret pivoting around the vertical axe on the chassis;
a power generator, not shown on the illustrations, providing power in usable form, i.e. mechanic or hydraulic and/or electric, in order to assure base 101 mobility and to power all the gear of the land drone 10 in order to make it as autonomous as possible.

In the aspect of the disclosed embodiment shown in FIG. 3, the base 10 is a battle tank turret.

Arm support 102 is attached at its lower end 112 to the base 101 and the head 103 is attached at its upper end 122 to the arm support 102. A main interface element of the head 103 interacts with a secondary interface element of the arm support 102 to form a mechanical interface and allow attaching of the head to said arm support.

Head 103 can be adapted to different types of carrier usually used in the industry, and containing arm and arm support unit, in which arm support of the head 103 can be attached instead of, for example, a nacelle. As a non limiting example, the head according the invention can, for example, be adapted to the arm and arm support unit, originated from aerial lift platform. Such base and platform lift arm support unit, and similarly, base 101, arm support unit 102 of the drone 10 are indicated in the description by the term “carrier” or “carrier vehicle”. In the description, the term “lift platform” is used to describe a device consisting of a carrier and a nacelle.

Beneficially, an adaptor may be used if necessary to adapt the primary interface element to the secondary interface element. The head 103 can be also attached on the arm support 102 presenting different secondary interface elements for different arms, using the adaptor if needed, without modifying the primary interface element. Such adaptors allow to attach head 103 to arm supports of platform lifts equipped with nacelles and initially intended for materials handling or lifting people.

A mechanical link of the mechanical interface between arm support 102 and head 103 is such as to it give said head at least one degree of freedom in relation to above mentioned arm support. For example, mechanical connection between arm support 102 and head 103 can be a pivoting connection or ball-in-socket connection.

In the shown configuration of articulated arm support 102 it is possible to raise the head 103 up to the 40 meters or more above the ground, using, for example, industrial platform lift carrier.

In an another aspect of the disclosed embodiment, the arm support 102 is not articulated. In an another aspect of the disclosed embodiment, the arm support 102 is telescopic. In general, the length and the number of degrees of freedom are adapted to the environment in which the drone 10 meant to be used.

As shown in FIGS. 1, 2 and 3, the head 103 has essentially a shape of a cylinder with polygonal base

In an another aspect of the disclosed embodiment, head 103 is self sufficient in energy, for example by means of an auxiliary power unit situated in the head.

An interface connection between arm support 102 and head 103 permits to communicate the orders from remote control system to the base 101 and arm support 102, in order to control the motion of said base and reconfiguration of said arm support. Furthermore, the interface connection allows transmission of power from base 101, for example from power generator to head 103. The interface connection can for example allow cables to pass between base 101, arm support 102 and head 103.

The head 103 comprises:
at least one environment perception system suitable for wide view field visual reconstruction of the drone's 10 environment, and implementing at least one environment sensor, the wide view field allowing to visualize the target in its own environment;
at least one mean for acting 104 with a narrow view field towards a preferred aiming line 105 included in the wide view field visual reconstruction of the drone. The narrow view field allowing to precisely isolate a target in its own environment;
means of information dissemination, for example speakers, screens.

The at least one environment perception system can contain for example one or more:
sensor, possible panoramic or almost so, of visible spectrum images, or of other spectrum, for example infrared;
distance sensor;
acoustic sensor;
temperature sensor;
wind speed sensor, for example used to contribute to the stabilization function of drone 10.

In an another form of embodiment, the at least one environment perception system features a field angle greater than forty five degrees.

The at least one means for acting 104 can contain for example:
an ammunition weapon;
a designation target system;
a bright projector;
an acoustic diffuser;
a jet, for example of water, of tear gas.

In an another aspect of the disclosed embodiment, at least one means for acting 104 comprises an angle of aperture lesser then 10 degrees, perhaps nearly zero, for example in the case of ammunition weapons. The angle of aperture is defined here as a maximum of angular amplitude of the narrow view field of one of the means for acting 104 reached at the whole of planes comprising the aiming line 105 of said means for action.

Each of the means for acting 104 comprises at least one degree of freedom in relation to the head 103 and is steerable in the frame of reference of said head.

Beneficially, the type and the quantity of environment sensors, number of the degrees of freedom and their location on the head 103 allows to sweep the whole or almost whole of the intervention site of the drone 10.

In FIGS. 1, 2 and 3, the head 103 is equipped with two weapons of diametrically opposing location and a not shown image sensor in the visible or non visible spectrum. The weapons of the head 103 can be lethal or not. Non lethal weapons can be par example weapons equipped with rubber bullets or tear gas bullets or water cannons.

At least one means for acting 104 of the head 103 is suited to the environment in which drone 10 is meant to operate. In the alternative form of implementation, it can for example contain one or more water cannons to repel aggressive individuals.

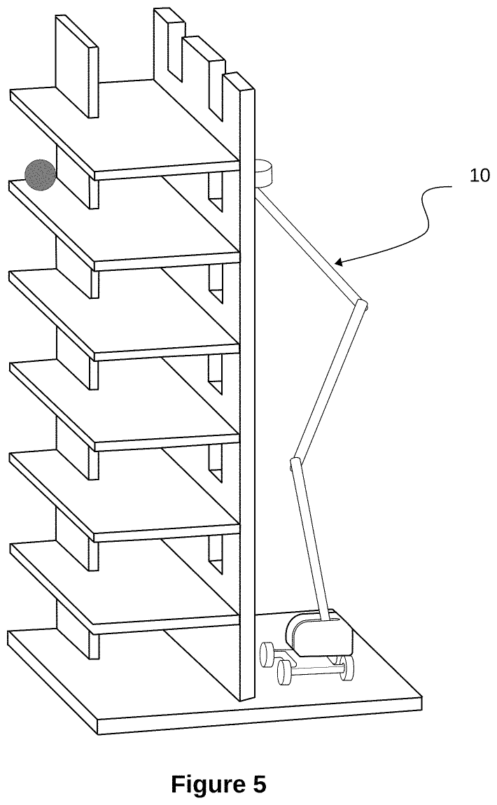

In relation to FIGS. 1 and 4, the control center 20 comprises visual display surface 201, here a screen 201 with essentially a rotunda shape, delimitating platform 202 on which the operators are placed. In the shown forms of implementation, screen 201 is essentially cylindrical. Projector (not shown) allows to view on the screen 201 the data captured and transmitted by the drone 10 by means of data transmission system 30. The transmitted data can be for example be images captured by the system of environment perception.

In the form of implementation, the screen 201 of control center 20 results from the assembly of juxtaposed basic screens in order to ensure the continuity of projected images

In the form of implementation, at least one screen 201 is essentially spherical or conical in shape.

The height of screen 201 in the shown examples has to allow to the individual on the platform 202 to view comfortably, meaning without data distortion that could lead to a wrong interpretation of above mentioned data, and without tiring the individual, for example due to eye strain or cramping. For a more comfortable visualization, the platform 202 may occupy a space less important than the one delimited by the rotunda, such that the distance of an operator to the screen 201 is superior to a minimal distance whatever the position of the operator is in the platform.

The dimensions and the position of the screen can be of cause adapted in order to allow to the operators to view the data in any position, for example lying down, standing up or in crouched position.

The shape of the control center 20 is not limited to this one form of implementation. For instant, in the non shown form of implementation of the disclosed embodiment, the head 103 of drone 10 comprises one or several sensors allowing capturing the environments of said drone in the view field essentially corresponding to a solid angle of 2π steradian. In this form of implementation, screen 201 of control center 20 preferably comprises one part shaped as hemisphere or dome. In an alternative aspect of the disclosed embodiment the view field of sensor of the drone 10 is wider then solid angle of 2π steradian. In an alternative aspect of the disclosed embodiment part of transmitted images is displayed on the 202 platform. In any case, the platform's surface can be adapted to allow sufficient viewing of the screen 201 by the operator, whatever their respective positions are on the platform.

In the example shown on illustration 4, the control center 20 comprises:
a station for tactical officer;
a station for piloting;
two stations for operators;
two stations for monitoring officers.

The cockpit is arranged so as to allow the pilot to remotely control the terrestrial drone 10, thanks to data transmission system 30 allowing piloting data transmission down from the control center 20 to the drone 10 and to allow the transmission of visual or not data sent by sensor of the drone 10 up from said drone to above mentioned control center. The so transmitted images allow to the operating pilot to apprehend the drone 10's position, environment and potential limits to its movements, linked for example to the presence of obstacles.

Operators at the occupying control positions control the at least one means for acting 104. Each operator is equipped with an aiming system, for example with a laser equipped system. Each system allows to control simultaneously one and unique mean of action 104 that is assigned to it. The direction of an aiming line 105 of given means for acting 104 is assigned to direction of the aiming line 205 given by the portable aiming system 203 to which said means for acting is assigned. Modification of orientation of the aiming system 203, and so of the direction of the aiming line 205 of said aiming system leads to modification of orientation of the means for acting 104 and of its direction of associated aiming line 105, so that when the operator aims at the screen of the control center 20 the image of the target retransmitted by drone 10 sensor, the associated means for acting 104 aims at the real target. Each aiming system 203 is also equipped with a trigger allowing to activate the associated remote means for acting 104 for example allowing to fire.

Each operator equipped with a portable aiming system is capable of moving on the platform, which allows him if necessary to place himself in function of his zones of interest and privileged observation zones at a given moment, in a position allowing him a visibility and improved comfort for identifying and following a target.

Beneficially, the at least one environment perception system comprises:
a distance sensor allowing to evaluate the distance to the target, for example sweeping laser LIDAR;
a wind speed sensor;
and the at least one means for acting 104 comprises:
an electronic Stability Program in order to ensure the function of correcting the trajectory;
a stabilizer, for example in case of fire arms, in order to compensate for the kickback during firing.

Visual field of the operator being limited, especially when concentrated on a target, two monitoring officers occupy each a monitoring position in order to cover the operators' dead angles:
observe continuously;
prioritize the observed elements;
transmit the information on the situation to the operators.

Beneficially, tactical officer occupying a tactical officer position supervises the whole operation, deciding the movements of the drone 10 and triggering the actions, for example fire.

In the shown example of an implementation, the pilot, the operators, the monitoring officers and tactical officer are standing up on the ground of the platform 202.

As mentioned earlier, the data transmission system 30 allows to transmit the data between drone 10 and control center 20, as shown on FIG. 1, ensuring:
uploading the data transfer from drone 10 to control center 20, for example the environment perception system data;
downloading data from control center 20 to drone 10, for example steering orders or triggering of the means for acting 104.

The data transmission system 30 can be in form of a wire connection, radio connection or satellite connection, or more broadly all combination of the resources that can be used by in the communication system, including those in order to ensure the consistency of the connection and the safety by encrypted connections to avoid hacking and misappropriation of the drone 10.

The device according to the disclosed embodiment can be used in a scope of various missions to which at least one environment perception system and at the least one means for acting are adapted.

In the first implementation method shown in FIG. 5, the device is implemented in the context of dislodgement of terrorists. In this implementation method the terrorist is hiding at the 5th floor of the building. The drone 10 according to the disclosed embodiment is located in building's immediate vicinity, and the head 103 is raised by the articulated arm 102 to the height of the 5th floor. The position and the sensors of the head 103, steerable thanks to aiming systems 203 operated by the operators of the control center 20, allow in this manner to have an outlook close to that the sniper could have if positioned on the neighboring building, at the same time ensuring the safety of the intervention forces since the drone 10 is remotely controlled from the control center 20 situated at the safe distance from the intervention site. The operator can also see from the control center 20 the inside of the apartment where the terrorist is hiding. The at least one means for acting 104 of the head 103 is adapted to the situation, so it can use for example a lethal arm sufficient to neutralize the terrorist through the windows of the apartment.

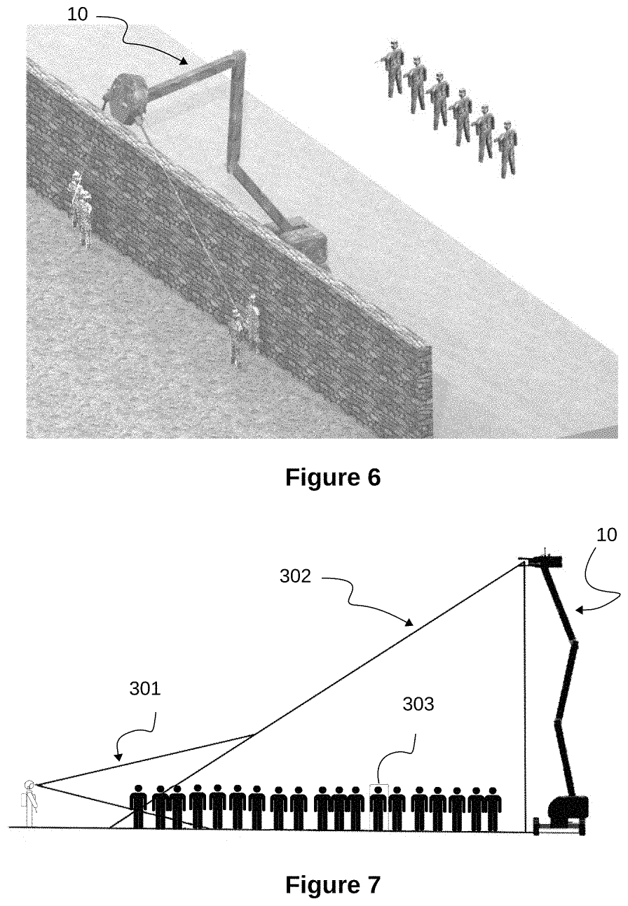

In the second implementation method shown in FIG. 6, the drone 10 is implemented in the context potentially dangerous for the law enforcement forces, for example a riot. In the shown implementation method dangerous individuals are hiding behind the side of the wall. Drone 10 situated close to the other side of the wall is at such configuration of the head 103 that it passes over the wall, allowing to inspect the zone non visible to the law enforcement forces and also to control the presence of dangerous individuals and their behavior. Orientation of the head 103 and consequently the view field recreated by the sensors can be modified by the adjustment of the arm support 102, for example, the height. Orientation of a sensor can also be modified by the associated operator. At least one of the means for acting 104 can contain lethal or non lethal weapons, allowing to neutralize the individual depending on how dangerous they are. The safety of the law enforcement forces is so ensured.

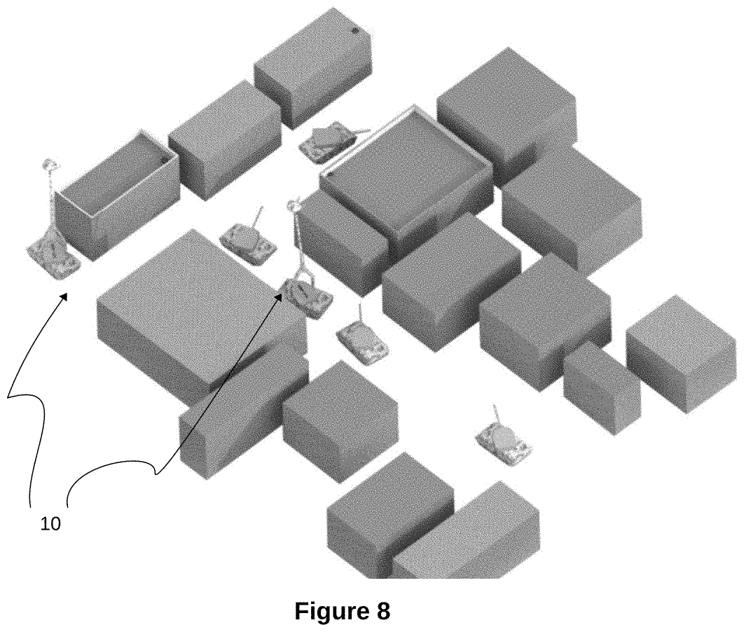

In the third implementation method shown in FIG. 7, the drone 10 is mainly used to monitor the crowd, for example in case of civil demonstration. Arm support 102 is extended in such configuration as to raise the head 103, for example to dominate the monitored sight, in the position essentially at the maximum height attainable by said head. In this implementation, the view field of the drone 10 allows to monitor the crowd effectively, as the comparison between grazing view field 301 of monitoring agent and the view field from the above 302 of the drone 10 according to the invention shows. The individual 303 cannot for example be seen by the ground agent, but is identifiable by the control center 20 controlling the drone 10.

In case a threat is detected, an appropriate means for acting 104 permits to neutralize it, for example thanks to rubber bullets or tear gas.

In the fourth implementation method shown in FIG. 8, two drones 10 according to the disclosed embodiment ensure the monitoring of a neighborhood and interception during the urban combat. The agility and dominant position of the heads 103 of the drone 10 allows the view and fire angles that are not possible with current techniques.

Also, the device 90 according to the disclosed embodiment allows to ensure the safety of the intervention teams, for example law enforcement agents, rescue teams, security enforcement teams by relocating the means of observation, means of strike, means for acting and means of measurement. The device 90 can as well be used instead of the intervention team, as in support to it.

The device 90 can be used for protective missions and interventions.

The device allows in particular:
to prioritize in a simple and intuitive way the observation, decision and action;
to obtain wider field of view of the site, for example a demonstration, in relation to one or several members of the monitoring of intervention team;
to avoid to expose the operators to risks as stray bullets or accidental shootings as well as dangers that they are supposed to eliminate;
to act as deterrent;
quick deployment at lesser cost.

The advantage of the device according to the disclosed embodiment is that the head of the drone is adaptable to different types of carrier equipped with a base and an arm support, for example industrial self propelling platform lifts.

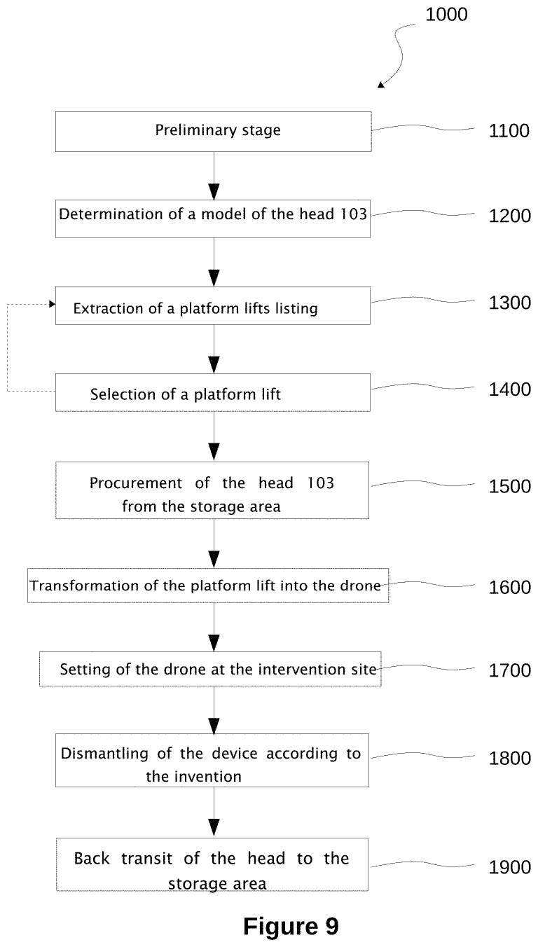

In relation to FIG. 9, the disclosed embodiment also concerns the method 1000 of control and intervention, allowing rapid implementation in hostile environment and in environment that can compromise safety of operators of the device 90 according the disclosed embodiment suitable for the environment and able to be deployed in a context of engagement at the intervention site.

The term intervention site means the geographical perimeter in which the disclosed embodiment will perform its mission. Intervention site can be for example a neighborhood in which the building where one or several terrorists are hiding is located. It can also be the area where the crowd is gathered for demonstration. In practice, the intervention site means a restricted area where the drone 10 during its implementation can be found to move around the ground.

During a preliminary stage 1100 of the method according to the disclosed embodiment, platform lifts comprising a mobile base, an arm support similar to those described in the presently disclosed embodiment, as well as a removable nacelle attached to the upper end of said arm support, and located in the area of interest on which the intervention site of found, are identified in the platform lift data base.

The mobile base and the arm support form a carrier vehicle on which the nacelle is attached.

By area of interest it is meant the expanded area on which drone 10 may be deployed according to the method 1000 of the disclosed embodiment. The area of interest can be par example a region or a country. Platform lifts are often found in the industry, for example amongst work site or handling equipment.

During this preliminary stage 1100, the localization of a platform lift, as well as of secondary interface elements allowing the coupling of the nacelle to the arm support, are listed. The listing beneficially identifies in addition to the storage site of the lifting platform its technical characteristics such as its capacities.

Also, during this preliminary stage 1100 the data base is regularly updated, for example as soon as a new platform lift is used for instance at the construction site. Similarly the data base is updated as soon as the perimeter related to the platform changes, for example it's localization changes, or when the platform lift is discharged and becomes unusable, in which case the platform lift is removed from the data base.

Beneficially, real time mapping (at least regularly updated) is created allowing to see the localization of the platform lifts listed for the area of interest, for example a city, a region or a country.

The goal of the listing in the database of platform lifts available at the area of interest is to allow rapid deployment of the drone 10 according to the current method on the intervention site when necessary, as said database allows to identify the available platform lifts closest to said intervention site.

During an initial determination 1200 stage, the model of the head 103 of the drone 10 to be used in the context of the mission is determined. Model of the head 103 is defined in particular, but no exclusively by its means for acting 104.

The method 1000 according to the disclosed embodiment then comprises the extraction stage 1300 from the database of the listing of the platforms lifts compatible with the model of the head 103 determined during determination stage 1200 and located close to the intervention site. This stage starts at onset of the event requiring the deployment of the device according to the disclosed embodiment. This identification is beneficially eased by deployment during the preliminary stage 1100 of the mapping of localization of platform lifts.

The platform lift closest to the intervention site is then selected 1400. Said platform lift is definitely selected if it checks for conditions of availability and operability. In the opposite case this platform lift is neutralized and the same test if performed with the second closest to the intervention site platform lift. In the case when none of the platform lifts from the listing of the platform lifts checks for conditions of availability and operability, the database extraction stage 1300 is resumed with enlarged perimeter.

The platform lift is not available, for example, if it was removed from the area where it is referenced. It is not operable if for example secondary interface element of arm support cannot work together with the primary interface element of the head 103.

In order to limit operability problems linked to the way of coupling, different models of head each having different primary interface element can be intended in order to increase the probability to have the model of the head that can fit the secondary interface element of selected platform lift. Also, a set of adaptors can be provided allowing to connect the unique primary interface element of the head 103 to the multitude of secondary interface elements frequently found in the platform lift field.

The method 1000 according to the disclosed embodiment then comprises procurement stage 1500 during which the head 103 of the drone 10 according to the disclosed embodiment is sent from the storage area of the heads 103 to the intervention site. The head 103 can for example be sent by truck or all other means of transport—ground, sea or air, allowing to quickly deliver said head to the intervention side.

Beneficially, storage area comprises heads 103 according to the disclosed embodiment potentially with means for acting 104 and different means of attaching from one head 103 to another. Beneficially, a multitude of storage areas can be established, each storage area intended to cover the zone, meaning likely to have a head 103 sent to any spot of said zone to be installed on the carrier of the lifting platform, said zone covering for example the radius of 100 kilometers around said storage area. The heads 103 determined to belong to the storage area can be selected depending on the types of the platforms lifts found in the zone of storage area. Each storage area contains variety of heads 103 having the connection elements and different means for acting as well as the quantity of the heads allowing to ensure the disponibility of the head 103 for any type of mission, the quantity of the heads depending on probability of the intervention in the zone covered by the storage area.

The platform lift is then transformed 1600. The head 103 is then installed on the arm support 102 of the carrier of the platform lift, after removing of the nacelle initially present on the arm support 102. When head 103 is installed, the base 101, the arm support 102 and above mentioned head form a drone 10 according to the disclosed embodiment. The head 103 comprises the elements necessary to the remote control of the drone 10, installation of the head 103 allows to control above mentioned so formed drone 10 from the control center as previously described or from a local piloting center, particularly for the pre positioning of said drone. Mechanical connection and connection between arm support 102 and head 103 allow specifically to transmit the motion orders to the carrier received from the remote control system.

Once the head 103 is transformed 1600, the drone 10 can be set into position 1700 for example according to one of the methods of deployment previously described.

Taking into consideration the diversity of drone 10 missions, the storage area beneficially comprises the heads 103 having means for acting 104 different from one head to another, for example fire weapon, suppression weapon, water cannon. In the later case the water cannon can be connected to a fire hydrant during deploying into position of the drone 10 according the method 1000 earlier described.

When the mission is carried out, abandoned or aborted, the head 103 is uninstalled during an uninstallation 1800 stage of the drone 10. The initial nacelle is placed back on the arm support 102 of the carrier of the platform lift.

Finally, at a stage 1900, the head 103 is sent back to the storage area.

Because of the quantity and availability of the platform lifts actually available due to it being widespread on the industry, the advantage of this method is that it allows to act fast, in different contexts of inspection, monitoring and intervention missions, in hostile environments, thanks to adaptability of the heads 103 of drone 10 according to the invention to different types of existing platform lifts.

Aside from the advantages related to the device and mentioned earlier, this method allows great responsiveness of the law enforcement agencies in case of an emergency, and requires little resources, since the elements necessary to the assembling and positioning of the drone 10, aside from head 103, for example fire hydrant and platform lifts, are found in or close to the risk area.

What is claimed is:

1. An intervention device intended to be deployed in a hostile environment, comprising:
a remotely operated land drone comprising:
a base being self-propelling and energy self-sufficient;
an arm support consolidated with said base by a lower end of said arm support;
a head consolidated with an upper end of said arm support;
a control center physically separated from the drone and arranged so as to allow the remote control of said drone by a remote operator of said control center;
a data transmission system allowing uploading data from the drone to the control center and downloading data from said control center to said drone; wherein:
the head comprises:
at least one environment perception system suitable to the wide view field visual reconstruction of the drone environment;
one or more narrow field means for acting employed following a preferred direction defined by an aiming line within the drone's environment wide view field visual reconstruction; said aiming line being oriented according to a reference related to the head;
the control center comprises;
a visual display surface for images, suitable for displaying the wide view field visual reconstruction of the drone's environment;
a platform of operators, dimensions and position of said visual display surface being adapted to allow the operators to observe from said platform images displayed on said visual display surface;
one or more portable aiming systems, each one being equipped with an aiming line, wherein each aiming system:
is intended to be controlled by an operator found on the platform, and equipped with said aiming system
controls an only and unique means for acting to which said aiming system is associated
is arranged to designate a given point on the visual display surface;
said aiming system being also provided with a validating control function of the designated point;
the uploading data comprising information data from the environment perception system, said data being treated upon reception to visually reconstitute the drone's environment and display in real time said reconstruction on the visual display surface;
the downloading data comprising information transmitted in real time, to orient the at least one means for acting associated with said at least one portable aiming system to point a target in the drone's real environment corresponding to a target corresponding to the point designated on the visual display surface by the aiming system.

2. The intervention device according to claim 1, wherein the base and the arm support originate from a military vehicle or civil platform lift.

3. The intervention device according to claim 1, wherein the arm support and head are connected by an adaptor.

4. The intervention device according to claim 1, wherein the data transmission system implements one of more wire connections and/or one or more wireless/radio connections, terrestrial or satellite.

5. The intervention device according to claim 1, wherein at least one of the environment perception systems comprises an image sensor and/or a sweeping distance sensor.

6. The intervention device according to claim 1, wherein at least one of the environment perception systems features a field angle of view greater than 45 degrees and at least one of means for acting features an angle of aperture lesser than 10 degrees.

7. The intervention device according to claim 1, wherein at least one of the mean for acting comprises at least one weapon, potentially lethal.

8. A method for implementing, in case of engagement at an intervention site, an intervention device according to claim 1, wherein it comprises following stages:
determination of a model of the head to implement depending on an intervention profile;
extraction from a database of a listing of civilian or military platform lifts, each equipped with a nacelle, said platforms being compatible with the head model determined during determination stage, identified in said database and stored in a given perimeter of the intervention site;
selection of a platform lift identified in the listing as closest to said intervention site, test of the availability conditions and operability of said platform lift and, in a case of negative result, removing said platform lift from said listing and rerun of the stage up to the identification of a usable platform lift, if necessary rerun of the stage of the extraction within enlarged perimeter;
transformation of the platform lift into drone by removing the nacelle from the platform lift selected in the selection stage to form a base provided with an arm support and attaching the head to said arm support in order to form a drone of the intervention device;
setting of the drone at the intervention site and coupling of the said drone with the control center by the data transfer system.

9. The method according to claim 8, wherein it comprises a preliminary stage of identifying, in the database, the emplacements of the platform lifts equipped with nacelles and located in the area of interest where the intervention site is located.

10. The method according to claim 8, wherein it comprises furthermore:
a stage of transit of said head from a heads storage area to the chosen platform lift;
a stage of dismantling of the head and the reinstallation of the nacelle at the end of the device's engagement;
a stage of back transit of said head from the intervention site back to said storage area.
